(19) United States
(12) Patent Application Publication
(10) Pub. No.: US 2005/0227646 A1
(43) Pub. Date: Oct. 13, 2005

(54) Detecting and maintaining linearity in a power amplifier system through comparing peak and RMS power levels

(76) Inventors: Ryo Yamazaki, Suwanee, GA (US); William Noellert, Atlanta, GA (US); Stephen Pratt, Cumming, GA (US)

Correspondence Address: SMITH FROHWEIN TEMPEL GREENLEE BLAHA, LLC, P.O. BOX 88148, ATLANTA, GA, 30356, US

(21) Appl. No.: 10/803,760

(22) Filed: Mar. 18, 2004

(51) Int. Cl. H04B 1/04

(52) U.S. Cl. 455/127.3; 455/115.1

(57) ABSTRACT

Small portable communication devices that support multiple modulation techniques cannot gain the benefits of using an isolator at the output of a power amplifier to provide stability in the load impedance. However, for communication devices that include amplitude modulation schemes, maintaining linear operation of the power amplifier is still required. In the presence of unstable load impedance, this can be a difficult task. As a solution, the linearity of the power amplifier is detected by determining the peak power of the output signal and the average or root-mean-square of a portion of the output signal, such as a mid-amble). The ratio of the peak power and the average power of the output signal are used to determine if the power amplifier is operating in the linear region. If the ratio is too high, then the power amplifier may be operating in the linear region. By adjusting the power level of the input signal to the power amplifier when the ratio increases, linearity of the power amplifier is maintained.

### CROSS-REFERENCE TO RELATED APPLICATIONS

This application is related to U.S. patent application Ser. No. __/______ entitled “DETECTING AND MAINTAINING LINEARITY IN A POWER AMPLIFIER SYSTEM THROUGH ENVELOPE POWER COMPARISONS” filed on the same date at this application and commonly assigned to the assignee of this application, which application is incorporated herein by reference in its entirety.

### TECHNICAL FIELD

The present invention is directed towards radio frequency transmission technology and, more specifically, towards a technique to detect and maintain linearity in a power amplifier for transmission systems that require linearity but do not have a stable output impedance or are susceptible to other conditions that can result in non-linear transmission.

### BACKGROUND

Cellular telephone technology has greatly advanced since its inception in the early 80's. Today, several cellular technologies are deployed throughout the world. One of the more prominent of the cellular technologies is the Global System for Mobile communication (GSM). GSM is a digital cellular communications system that was initially introduced in the European market but, it has gained widespread acceptance throughout the world. It was designed to be compatible with ISDN systems and the services provided by GSM are a subset of the standard ISDN services (speech is the most basic). Another advancement in cellular technology includes the General Packet Radio Service (GPRS) which is a packet based air interface that is overlaid on the existing circuit switched GSM network. GPRS is a non-voice value added service that allows information to be sent and received across a mobile telephone network.

The operational components of a GSM cellular system include mobile stations, base stations, and the network subsystem. The mobile stations are the small, hand-held telephones that are carried by subscribers. The base station controls the radio link with the mobile stations and the network subsystem performs the switching of calls between the mobile and other fixed or mobile network users. Because multiple cellular systems exist in the world, some mobile stations support more than one technology. Such mobile stations are typically referred to as “world phones” meaning that they can be used on a variety of different cellular system around the world.

Various cellular technologies utilize different modulation schemes. For instance, the GSM transmission technology utilizes the Gaussian Minimum Shift Keying form of modulation (GMSK). In this modulation scheme, the phase of the carrier is instantaneously varied by the modulating signal. Some of the important characteristics of GMSK modulation are that the output signal has a constant envelope, a relatively narrow bandwidth and a coherent detection capability. However, the most important characteristic of these characteristics is the constant envelope. Signals that have a constant envelope are more immune to noise than signals that have varying amplitudes.

In addition, because GMSK modulation does not include amplitude components, a purely GMSK transmitter does not require the use of a linear power amplifier. This is advantageous because when amplifiers are operating in the non-linear region, they typically deliver much higher efficiencies than when they are operating in the linear region.

GPRS also uses GMSK in modulating the data being transmitted through the cellular network. The modulation schemes for both GSM and GPRS result in a transmission rate of 271 ksps (kilo-symbols-per second) at a 1-bit/symbol rate. To utilize the bandwidth more efficiently, Enhanced GPRS (or EGPRS) was introduced. Using EGPRS, the symbol rate is still 271 ksps but, rather than 1-bit per symbol, 3-bits per symbol are utilized thereby increasing the bit rate to 813 kbps. To accomplish this, a more efficient modulation scheme called 3π/8 8PSK is utilized. As previously mentioned, GMSK modulation has phase components and does not include amplitude components. However, 3π/8 8PSK modulation does contain amplitude information and thus, requires a linear power amplifier to ensure that the amplitude information is not distorted during amplification.

Thus, in a mobile station that supports both GSM and EGPRS, it is evident that linearity in the power amplifier must be maintained. This is also true in most any multi-technology mobile station that includes both phase and amplitude information in the modulated signal. When the linearity of the power amplifier in such a mobile station is compromised, the required operating specifications for parameters such as adjacent-channel power ratio (ACPR) and error vector magnitude (EVM) can be violated.

Those skilled in the art will be aware that several factors operate against maintaining linearity in a power amplifier. These factors include, among other things, the operating temperature, the level of the supply voltage and the load impedance. For instance, with regards to the load impedance, the antenna of a mobile station can present a mismatch of up to a 10:1 voltage standing wave ratio. Traditionally, isolators have been used at the output of a power amplifier to present the power amplifier with a matched load impedance. However, today's mobile stations must be smaller, less expensive and support multiple frequency bands and transmission technologies. Because isolators are typically large, expensive and support only narrow bandwidths (which requires the use of multiple large and expensive isolators in multi-band phones) it is no longer practical to use an isolator. Thus, there is a need in the art for a method to maintain linearity in a power amplifier without the use of an isolator. In addition, there is a need in the art for a method to detect degradation in the linearity of a power amplifier and make adjustments to maintain linearity. There is also a need in the art for a method to detect non-linearity in a power amplifier when modulation schemes that require linearity are being used but to ignore such restraints when linearity is not required.

### SUMMARY OF THE INVENTION

The present invention provides a solution to the deficiencies in the current art by providing a technique to detect degradations in the linearity of a power amplifier and adjust the power level of the input signal to the power amplifier if degradations in the linearity of the power amplifier are detected. More specifically, the present invention operates to detect the output signal from a power amplifier. The peak power of the output signal is then determined. In addition, the average power, or the root-mean-square (RMS) power of at least a portion of the output signal is determined. When the linearity of the power amplifier begins to degrade, there is an increase in the ratio of the peak power to the RMS power. Thus, by monitoring the peak power and the RMS power levels, the present invention operates to detect degradation in the linearity of the power amplifier. The present invention then operates to restore linearity in the power amplifier by adjusting the power level of the signal being input to the power amplifier. The present invention can also restore linearity by adjusting the bias of the power amplifier or the power supply voltage to the power amplifier. Thus, the present invention operates to detect linearity in the operation of a power amplifier and to maintain linearity in the operation of the power amplifier. An additional aspect of the present invention is that the efficiency of the power amplifier can be improved. By monitoring the linearity of the power amplifier, the bias of the power amplifier can be lowered to improve efficiency without compromising linearity.

### BRIEF DESCRIPTION OF THE DRAWINGS

FIG. 1 is a circuit diagram illustrating an exemplary embodiment of the present invention.

FIG. 2 is a timing diagram illustrating a typical 3π/8 8PSK based signal.

FIG. 3A is a table illustrating typical test measurements that were taken of a power amplifier that is terminated into a 50 Ohm load.

FIG. 3B is a table illustrating typical test measurements that were taken of a power amplifier that is terminated into a mismatched load.

FIG. 3C is a diagram illustrating a typical test setup that could be used for obtaining the data samples found in FIGS. 3A-3B.

FIG. 4 is a circuit diagram illustrating the incorporation of temperature and voltage compensation into present invention.

FIG. 5 is a flow diagram illustrating the operations of the present invention.

### DETAILED DESCRIPTION

The present invention provides a solution to the above-describe problems and needs in the art. The present invention includes a method and circuit for detecting the linearity of a power amplifier system, and to maintain linearity within the power amplifier system. One benefit of the present invention is that the bias of the power amplifier can be lowered to improve efficiency while still monitoring and maintaining the linearity of the power amplifier. More specifically, several factors, such as the operating temperature, the level of the supply voltage and the load impedance, operate to destroy linearity in a power amplifier. EVM is used to measure the modulation quality of a 3π/8 8PSK modulated signal and when the above-listed conditions are present, the amplitude error dominates the total EVM. AM to PM distortion affects the phase component of the 3π/8 8PSK modulated signal at the power amplifier output, but has minimal affect to the overall EVM and can be ignored when trying to determine the linearity within the power amplifier. The ratio of the peak power in the envelope of the output signal to the root-mean-square (RMS) power level is monitored by the present invention. This ratio has a direct correlation with the EVM, or linearity of the power amplifier. The present invention operates to measure linearity by using a detector at the output of the power amplifier to detect the output signal power during the mid-amble and to determine the peak power in the remainder of the 3π/8 8PSK signal's envelope. The mid-amble portion of a 3π/8 8PSK signal has a constant power envelope and represents the RMS power of the measurement. The peak power represents the maximum peak level that is measured in the remainder of the 3π/8 8PSK signal. Based on the ratio of the peak power to the RMS power, an algorithm is applied to calculate the degradation in linearity of the power amplifier and to determine how much the power level of the input signal to the power amplifier should be adjusted.

Now turning to the drawings in which like numerals and references refer to like elements throughout the several views, various aspects and embodiments of the present invention are described.

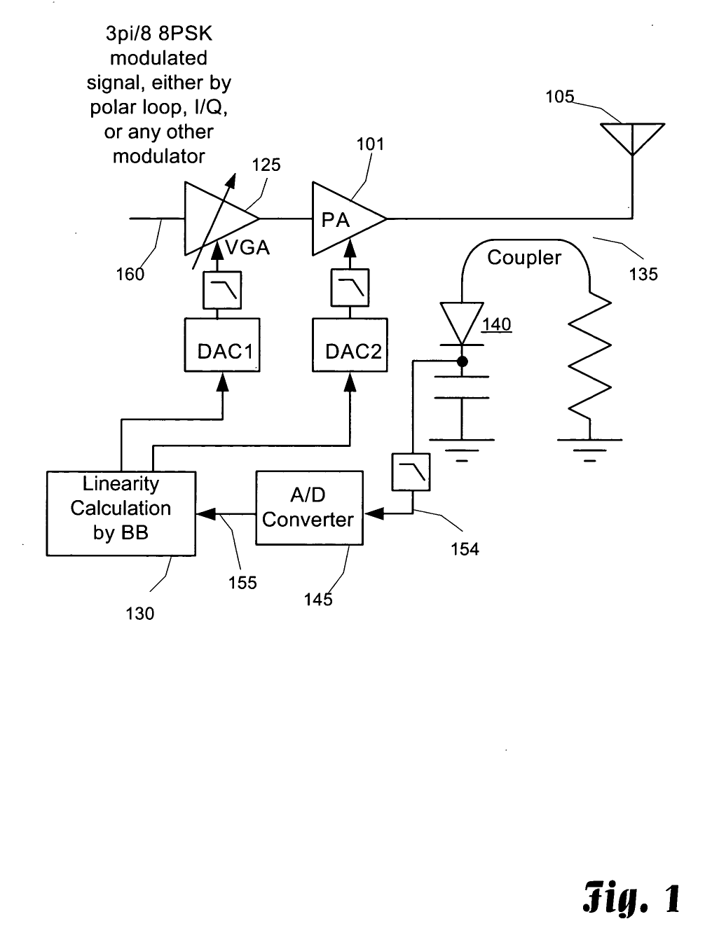

FIG. 1 is a circuit diagram illustrating an exemplary embodiment of the present invention. The circuit includes a power amplifier 101 that is used to amplify an input signal 160 for transmission to the antenna 105. The input signal 160 could be a variety of different types of signals, including but not limited to a 3π/8 8PSK modulated signal that are generated through a polar loop, I/Q quadrature or any other modulator. In addition, the input signal 160 may be a combination of a phase modulated signal that is further modulated by an amplitude modulated (AM) envelope. Regardless of the modulation technique, the input signal 160 is then amplified through the variable gain amplifier 125 prior to being provided to the power amplifier 101. The output signal to be transmitted from antenna 105 is available at the output of the power amplifier 101.

The output of the power amplifier 101 is fed directly to the antenna 105 for transmission. A coupler 135 is used to sense the output of the power amplifier and the output signal is detected across voltage detector 140. The detected voltage 154 is provided to analog-to-digital converter 145 and the detected digitized signal 155 is then provided to the processor 130.

The processor 130 receives the detected digitized signal and then determines the two power parameters of (a) peak power of the envelope and (b) RMS power during the mid-amble of the signal.

Thus, the present invention can be implemented in a circuit for maintaining linear operation of a power amplifier. The circuit includes a power amplifier, a variable gain amplifier, a coupler, a voltage detector, and a processor. The power amplifier includes a signal input and a signal output. The variable gain amplifier also includes a signal input and a signal output, as well as a control input. The signal output of the variable gain amplifier is connected to the signal input of the power amplifier and the signal input of the variable gain amplifier receives a modulated signal that has been modulated with a base band signal. The control input of the variable gain amplifier is connected to a control output of the processor. The output signal from the power amplifier is detected through the coupler and the voltage detector and the envelope of the detected signal is provided to the processor.

In operation, the input power level to the power amplifier is set to a normal level and the processor receives the detected digitized signal and determines the peak power and the RMS power (mid-amble) of the detected signal. The larger that the value of this ratio is, the better the linearity of the power amplifier. It should be understood that the present invention can be implemented using positive or negative logic. For simplicity, the present invention is only described as using positive logic; however, the aspects of the present invention can equally apply to negative logic circuits, If the ratio of these two parameters is below a minimum threshold level, then the processor limits the power of the input signal to the power amplifier by adjusting the gain of the variable gain amplifier. If the ratio exceeds a maximum threshold, then the processor can increase the power of the input signal; however, the increase should not exceed the normal level. If the ratio is between the maximum and minimum threshold levels, then the processor can simply maintain the current power level of the input signal. In addition, the power amplifier can include a control input and the processor can further adjust the gain of the power amplifier, in conjunction with or in lieu of adjusting the gain of the variable gain amplifier.

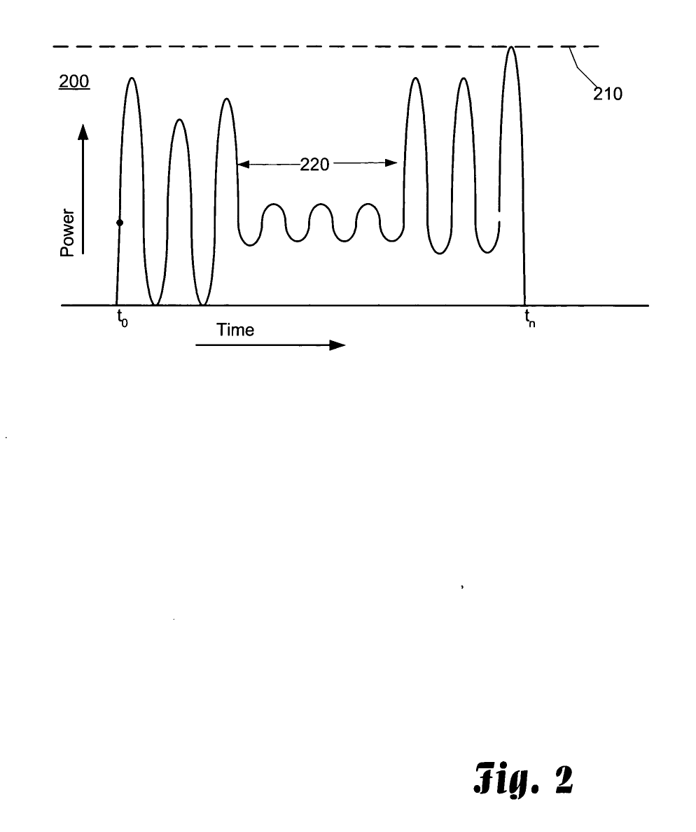

FIG. 2 is a timing diagram illustrating a typical 3π/8 8PSK based signal. The 3π/8 8PSK based signal in FIG. 2 includes a transmitted signal 200 that begins at point to and ends at point tₙ. The peak power of the envelope is illustrated by dotted line 210 and is basically the maximum power level of the envelope. The processor 130 examines the input detected and converted input signal to determine the peak power of the envelope. In addition, the processor 130 determines the root-mean-square (RMS) value of the mid-amble 220 or the synchronization pulse that is included in the middle of a 3π/8 8PSK based signal. Those skilled in the art will be aware of the necessary calculations and measurements required to determine the peak power and the RMS of the mid-amble. One of the advantages of the present invention is that the RMS power can be measured during the mid-amble synchronization signal (or the pre-amble or post-amble) instead of over the entire burst. If the power of the entire burst is measured, the dynamic range of the detector must ensure linear detection at lower peaks as well as at higher peaks. If you look at this range in a 3π/8 8PSK signal, the peak to null ratio can be from 16 to 17 dB. Thus, the detector would require a large dynamic range to measure the power of the high and low peaks. The mid-amble has a constant amplitude envelope and the power can be measured with a detector that has less dynamic range than one that has to measure the high and low peaks of a 3π/8 8PSK signal.

Once the processor has determined the peak power of the envelope and the RMS power during the mid-amble, the processor can examine the ratio of the peak power to the RMS power to determine the linearity of the power amplifier.

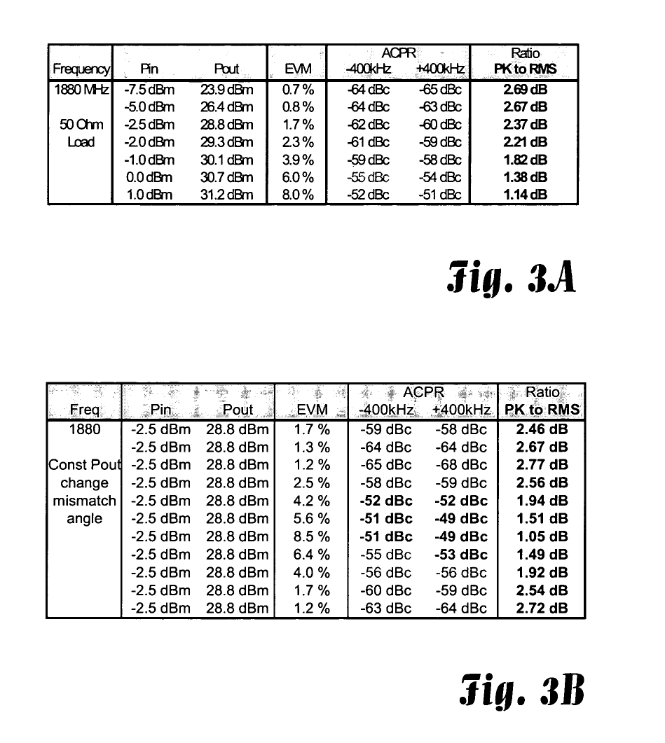

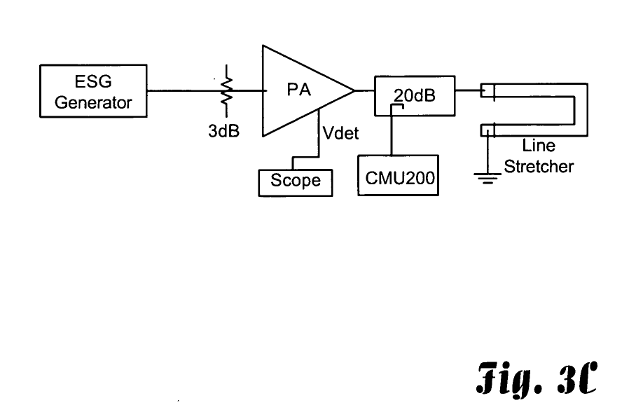

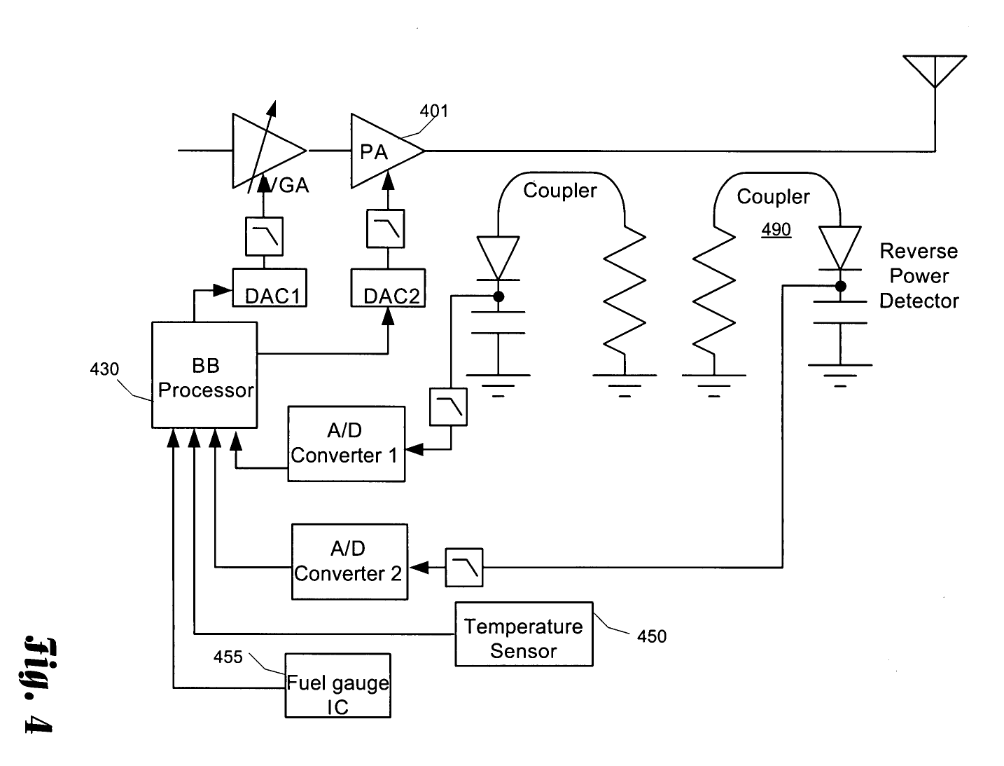

FIG. 3A is a table illustrating typical test measurements that were taken of a power amplifier that is terminated into a 50 Ohm load. The power level Pin of the input signal was varied from −7.5 dBm to 1.0 dBm to the power amplifier input. From the table in FIG. 3A, it can be seen that as EVM and ACPR begin to degrade due to compression, the peak to RMS ratio also drops. When the values of EVM and ACPR degrade, then the linearity of the power amplifier is degrading. Thus, by monitoring the ratio of the peak power to the RMS of the mid-amble, the present invention is able to detect when the linearity of the power amplifier is degrading. When this condition is detected, the processor can lower the power of the input signal to the power amplifier to restore linear operation.

FIG. 3B is a table illustrating typical test measurements that were taken of a power amplifier that is terminated into a mismatched load. The VSWR on this load ranges from 6 to 7.5, which is right in the pertinent range. The input power to the power amplifier is kept constant at −2.5 dBm, which relates to an output power in 50 Ohms of 28.8 dBm. The phase angle of the load was then varied and EVM, ACPR, and peak power to RMS power of the mid-amble ratios were recorded and calculated. The data presented indicates that as EVM and ACPR degrade, the ratio of the peak power to RMS power of the mid-amble degrades also.

FIG. 3C is a diagram illustrating a typical test setup that could be used for obtaining the data samples found in FIGS. 3A-3B.

An advantage of the present invention is realized in the use of a power detector. This aspect of the invention enables automatic power control to be incorporated into the system by implementing it within an integrated circuit, such as the base band processor. For modulations that have an amplitude that is varying, the use of a traditional closed loop power control system is not recommended because the control loop can remove the amplitude envelope. Those skilled in the art will recognize that various techniques of power control can be used such as sample-and-hold detectors and open loop control to accurately set the output power verses closed loop control. Any of the methods for power control can be implemented in hardware or software within the base band processor. A sample-and-hold system can be achieved digitally so that more accurate power control is achieved. This is important because it allows the linearity control loop to compensate for bad EVM/ACPR by reducing the power into the power amplifier while staying within the output power requirements. Because the power control loop is achieved digitally, the time constant of the control loop can be adjusted easily, making it possible to adapt the loop bandwidth for optimum ramping under different conditions. Linear power amplifiers with fixed bias optimized for maximum power and linearity show extremely poor efficiency at low power levels. With the use of the linearity detection methods of the present invention, the bias of the power amplifier can be lowered to increase efficiency while still maintaining linearity. A lower bias on the power amplifier will result in the power amplifier having a lower gain and compression point and thus, the power amplifier will draw less current.

Those skilled in the art will also realize that the present invention can be used to increase the bias of the power amplifier when the communication device is connected to an external power source. When connected to an external power source, efficiency of the power amplifier is not as much of a concern as when the communication device is being operated by battery power. Thus, when the communication device is receiving external power, the drain current of the power amplifier can be increased by raising the bias, and thereby improve the linearity without reducing the output power.

FIG. 4 is a circuit diagram illustrating the incorporation of temperature and voltage compensation into present invention. By using temperature and/or voltage compensation, the accuracy of the operation of the present invention in adjusting the linearity of the power amplifier can be improved. Based on the temperature of the power amplifier sensed by the temperature sensor 450 and/or the level of the voltage supplied to the power supply input of the power amplifier as detected by the fuel gauge 455 (coulomb counter), the processor 430 can add an offset to the power amplifier 401 input power or to the bias control input to compensate for the affects that these variables have on the linearity and gain of the power amplifier. In addition, the circuit in FIG. 4 illustrates the use of an additional detector 490 at the power amplifier 401 output. The additional detector 490 operates to detect the reverse power in extreme VSWR conditions. This information can be used by the processor 430 to further aid in calculating the linearity compensation requirements. Typically this is true when the battery or supply voltage is at a sufficient level. Thus, when performing this operation, the voltage level should be monitored to ensure the supply is sufficient, or the operation can be limited to only when an external power supply is connected, such as a car charger. For example, if the VSWR detected by the additional detector 490 is high, the processor 430 can increase the power amplifier bias to operate the power amplifier in a more linear mode and thus compensate for the effects of VSWR. Thus, the use of the additional detector 490 provides even more feedback information to the processor 430, that the processor can use in determining if the power amplifier 401 is operating in the linear region.

In one embodiment of the invention, threshold levels can be established with regards to the ratio of the peak power to the RMS power of the mid-amble. (If the ratio is above a maximum threshold level, this may indicate that the power amplifier is operating well within the linear region and thus, the power level of the input signal can be increased without degrading the linearity of the power amplifier. However, the power level should not be increased beyond an initial target value for the power amplifier. If the ratio is less than a minimum threshold level, the power amplifier is not operating in the linear region and the power level of the input signal must be decreased to restore linearity of the power amplifier. If the ratio is somewhere between the maximum and minimum thresholds, then linear operation of the power amplifier can be assumed and no adjustments will be necessary.)

The circuit of FIG. 1 can be incorporated into a variety of transmitting products including, but not limited to, cellular telephones, cellular repeaters, cellular boosters, transmission tower, radio frequency transmitters, etc. The present invention is most applicable within multi-technology and multi-banded mobile stations. The present invention allows the maintenance of linearity for a power amplifier even in the presence of an unstable or changing load impedance. Thus, even in the absence of an isolator at the output of the power amplifier, the present invention operates to maintain linear operation of the power amplifier.

In one embodiment, the present invention can be incorporated into a mobile station for use in a cellular system. In this embodiment, the mobile station will include a power amplifier that has a signal input received from a variable gain amplifier and a signal output for transmitting through an antenna. Coupled to the output of the power amplifier, a voltage detector operates to detect the output signal to obtain a detected signal output. The detected signal output can be converted into a digital signal through the use of an analog to digital converter. This digital signal is then provided to a processor. The processor, in response to receiving a detected signal, operates to determine the peak power of the digital signal and the root-mean-square power of at least a portion of the digital signal. These values then form a ratio that is used to determine if the power amplifier is operating in the linear region and if not, the processor can adjust the gain of the variable gain amplifier in accordance with the value of the ratio.

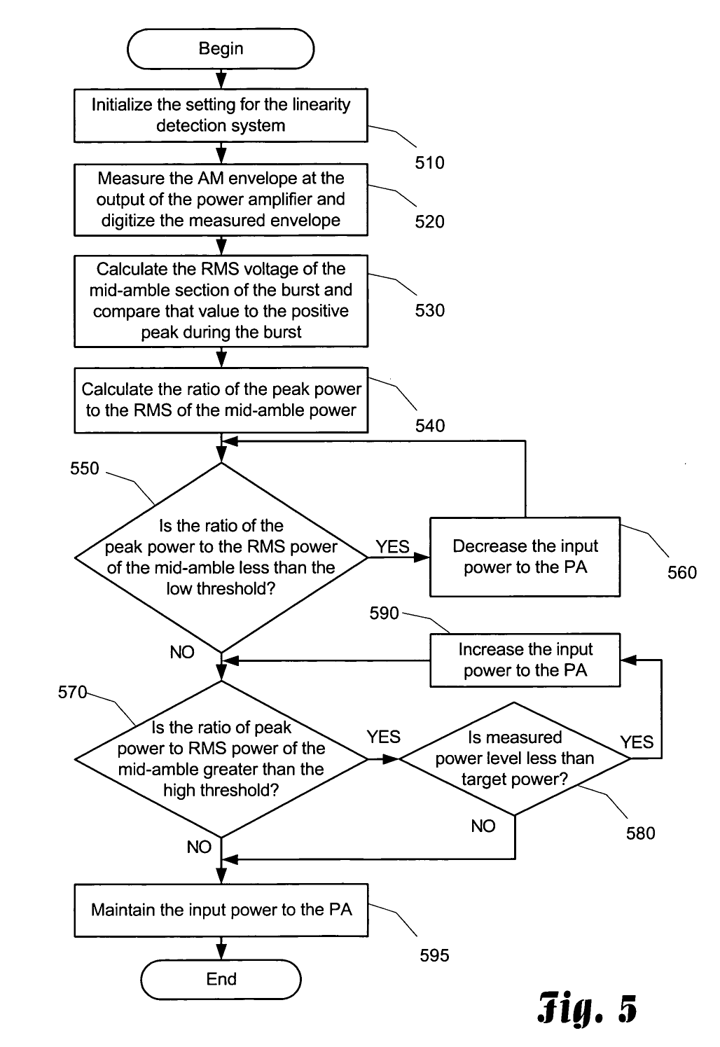

FIG. 5 is a flow diagram illustrating the operations of the present invention. Upon applying power to the communication device housing a transmitter that incorporates an embodiment of the present invention, the transmitter is initialized. This process involves, among other things, setting the gain of a variable gain amplifier and the power amplifier at step 510. At step 520, the transmitter is in operation and the present invention is operating to detect and maintain operation of the power amplifier within the linear region. At step 520, the AM envelope of the output signal is measured and digitized. At step 530, the RMS voltage of the mid-amble section of the burst is calculated and the value is compared to the positive peak during the burst. Steps 520 and 530 can be performed in a variety of manners and the illustrated technique of detecting and converting the signal to a digital representation and having a processor analyze the digital signal is only one such technique. At step 540 the ratio of the peak power to the RMS of the mid-amble power is calculated. At decision block 550, the ratio of the peak power and the RMS power is examined. If the ratio is too low, this indicates that the linearity of the power amplifier is degrading. In this case, processing continues at step 560, where the power level of the signal being input into the power amplifier for amplification is decreased to restore linearity to the operation of the power amplifier.

If the ratio is higher than the low threshold then processing continues at decision block 570 where the ratio of peak power to RMS power of the mid-amble is compared to an upper threshold? If the ratio is greater than the upper threshold, then processing continues at decision block 580. At decision block 580, the measured power level is compared to the target power level and if it is less, the processing continues at step 590. At step 590, the input power to the power amplifier is increased and processing returns to decision block 570. However, if at decision block 580, the measured power level is not less than the target power level, processing continues at step 595 where the power level to the power amplifier is maintained. The present invention can also operate to adjust the power level of the signal being input to the power amplifier based on output power changes that are due to changes in temperature or voltage conditions.

In one embodiment, two threshold levels are established. The threshold levels represent varying degrees in the peak power to RMS power ratios. For instance, a low ratio will approach a minimum threshold level and high ratio will approach a maximum threshold level. If the ratio drops below the minimum threshold level, the power level of the input signal should be decreased. If the ratio is above a maximum threshold level, then the power level of the input signal can be increased but not beyond a target output level. If the ratio is within the maximum and minimum threshold values, then the power level of the input signal should be maintained. It should be noted that the maximum and minimum threshold levels can be the same in some embodiments. In such an embodiment the power level of the input is decreased when the ratio drops below the threshold and is increased up to the target power level when the ratio is above the threshold.

In addition, the ratio calculation and comparison aspect of the present invention can be implemented within a single processor, such as the base band processor resident in cellular telephone or mobile station designs. The processing capability of such processors enables the comparison and analysis to be accomplished in a cost effective and time efficient manner.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method of detecting linear operation in a power amplifier, the power amplifier being operative to amplify an input signal for transmission, the method comprising the steps of:
detecting the output signal of the power amplifier;
converting the detected output signal into a digital signal;
examining the digital signal to determine the peak power represented by the digital signal;
examining the digital signal to determine the root-mean-square power of a portion of the digital signal;
decreasing the input power level of the input signal if the ratio of the peak power to the root-mean-square power below a first threshold level.

2. The method of claim 1, wherein the input signal is provided to the power amplifier through a variable gain amplifier, and the step of decreasing the input power level of the input signal comprises decreasing the gain of the variable gain amplifier.

3. The method of claim 1, further comprising the step of increasing the input power level of the input signal if the ratio of the peak power to the root-mean-square power is above a second threshold level.

4. The method of claim 1, further comprising the step of maintaining the input power level of the input signal if the ratio of the peak power to the root-mean-square power is between the second threshold level and the first threshold level.

5. The method of claim 1, wherein the step of examining the digital signal to determine the root-mean-square power of a portion of the digital signal further comprises identifying the mid-amble portion of the signal and determining the root-mean-square power of the mid-amble portion of the signal.

6. A circuit for maintaining linear operation of a power amplifier, the circuit comprising the components of:
a power amplifier, a variable gain amplifier, a coupler, a voltage detector, and a processor,
the power amplifier having a signal input and a signal output;
the variable gain amplifier having a signal input, a signal output, and a control input, the signal output of the variable gain amplifier being electrically coupled to the signal input of the power amplifier, the signal input of the variable gain amplifier receiving a modulated signal that has been modulated with a base band signal, the control input of the variable gain amplifier being connected to a first control output of the processor,
the coupler being electrically coupled to the signal output of the power amplifier and operative, in cooperation with the voltage detector, to detect the envelope of an output signal at the signal output of the power amplifier and provide the detected envelope to a detected signal input of the processor;
the processor, being operative to:
receive the detected signal and determine the peak power of the detected signal and the root-mean-square power of at least a portion of the detected signal; and
adjust the first control output of the processor to limit the gain of the variable gain amplifier if the ratio of the peak power to the root-mean-square power is below a first threshold level.

7. The circuit of claim 6, wherein if the ratio of the peak power to the root-mean-square power is above a second threshold level, the processor is further operative to adjust the first control output of the processor to increase the gain of the variable gain amplifier if the output power is less than the target power level.

8. The circuit of claim 7, wherein if the ratio of the peak power to the root-mean-square power is between the first threshold level and the second threshold level, the processor is further operative to maintain the value of the first control output of the processor and thereby maintain the gain of the variable gain amplifier.

9. The circuit of claim 6, wherein if the ratio of the peak power to the root-mean-square power is below the second threshold level, the processor is further operative to maintain the value of the first control output of the processor and thereby maintain the gain of the variable gain amplifier.

10. The circuit of claim 6, wherein the power amplifier further includes a control input and the processor further includes a second control output that is electrically coupled to the control input of the power amplifier and, if the ratio is below the first threshold level, the processor is further operative to adjust the second control output to improve the linearity of the power amplifier and, if the ratio is above a second threshold level, to adjust the second control output to improve the efficiency of the power amplifier.

11. A mobile station for use in a cellular system, the mobile station comprising:
a power amplifier having a signal input received from a variable gain amplifier and a signal output for transmitting through an antenna;
a voltage detector coupled to the output of the power amplifier for detecting the output signal and obtaining a detected signal output;
an analog to digital converter electrically coupled to the output of the voltage detector for receiving the detected signal and for converting the detected signal from analog to a digital signal and providing the digital signal to a digital output;
a processor coupled to output of the analog to digital converter for receiving the digital signal, the processor being operative to:
determine the peak power of the digital signal;
determine the root-mean-square power of at least a portion of the digital signal;
determine the ratio of the peak power to the root-mean-square power; and
adjust the gain of the variable gain amplifier in accordance with the value of the ratio.

12. The mobile station of claim 11, wherein the processor is operative to adjust the gain of the variable gain amplifier by decreasing the gain if the ratio is below a minimum threshold.

13. The mobile station of claim 12, wherein the processor is further operative to adjust the gain of the variable gain amplifier by increasing the gain if the ratio is above a maximum threshold difference.

14. The mobile station of claim 13, wherein the processor is further operative to maintain the gain of the variable gain amplifier if the ratio is between the minimum threshold and the maximum threshold difference.

15. The mobile station of claim 14, wherein the processor is operative to determine the root-mean-square of the digital signal by detecting the synchronization bit sequence within the digital signal and determining the root-mean-square power of the synchronization bit sequence.

16. The mobile station of claim 14, wherein the processor is operative to determine the root-mean-square of the digital signal by detecting the mid-amble of the digital signal and determining the root-mean-square power of the mid-amble.

17. The mobile station of claim 11, further comprising a temperature sensor and, the processor is further operative to adjust the gain of the variable gain amplifier in accordance with the value of the ratio and the temperature reading of the sensor.

18. The mobile station of claim 11, further comprising a voltage sensor for measuring the voltage level of a source providing power to the mobile station and, the processor is further operative to adjust the gain of the variable gain amplifier in accordance with the value of the ratio and the level reading of the voltage sensor.

19. The mobile station of claim 11, further comprising a reverse power detector for detecting a voltage standing wave ratio and, the processor is further operative to adjust the gain of the variable gain amplifier in accordance with the value of the ratio of the peak power to the root-mean-square power and the voltage standing wave ratio.

20. The mobile station of claim 11, further comprising:
a temperature sensor and,
a voltage sensor for measuring the voltage level of a source providing power to the mobile station; and
the processor is further operative to adjust the gain of the variable gain amplifier in accordance with the value of the ratio of the peak power to the root-mean-square power and the temperature reading of the sensor and the level reading of the voltage sensor.
